(19) United States
(12) Patent Application Publication
(10) Pub. No.: US 2013/0109224 A1
(43) Pub. Date: May 2, 2013

(54) ELECTRICAL POWER CONNECTOR

(71) Applicants: Hsien-Ning CHIN, Taoyuan County (TW); Hao-Jan Tuan, Taoyuan County (TW)

(72) Inventors: Hsien-Ning CHIN, Taoyuan County (TW); Hao-Jan Tuan, Taoyuan County (TW)

(21) Appl. No.: 13/568,831

(22) Filed: Aug. 7, 2012

(30) Foreign Application Priority Data
Oct. 28, 2011 (TW) 100139404

(51) Int. Cl. H01R 13/00

(52) U.S. Cl. 439/485

(57) ABSTRACT

An electrical power connector includes an electrically insulative housing defining multiple front mating portions, multiple rear partition plates, an accommodation chamber between each two adjacent partition plates corresponding to one respective mating portion, a mating chamber in each mating portion and mounting holes on opposing top and bottom sides of the mating portions, pairs of conducting terminals respectively mounted in the accommodation chambers of the electrically insulative housing, and a heat dissipation mechanism including a plurality of thermal conductive metal plates fastened to the mounting holes of the electrically insulative housing with respective mounting lugs thereof and covered on the mating portions of the electrically insulative housing and for quick dissipation of heat.

This application claims the priority benefit of Taiwan patent application number 100139404, filed on Oct. 28, 2011.

### BACKGROUND OF THE INVENTION

1. Field of the Invention

The present invention relates to electrical connector technology and more particularly, to an electrical power connector, which effectively reduces the operating conducting terminal impedance and temperature.

2. Description of the Related Art

When designing an electrical connector, a designer normally will pay attention to two basic parts, i.e., signal and power supply. When designing a signal circuit, a designer normally will not consider the factor of current variation for the reason that the applied current is normally low. However, with respect to the transmission of signals, a designer may consider the nature of the carrier (high frequency, low frequency) and many other factors (static interference, magnetic interference, impedance matching, etc.) without taking the factor of temperature into account. With respect to power supply, conducting a high-current power supply through a power circuit will increase the impedance, causing a rise in temperature. Thus, when designing an electrical power connector, the factors of quick heat dissipation and low conducting terminal impedance must be considered, avoiding a significant change in the electrical characteristics. Further, an electrical connector of this kind is adapted for conducting power supply, its terminal contact surface area and the related heat dissipation arrangement will affect power transmission quality. An electrical power connector may be used in a power adapter or server and connected to a connection portion of a circuit board. When conducting a high current to cause a rise in impedance, heat will be produced, affecting system performance and operating safety.

FIG. 8 illustrates an electrical power connector according to the prior art. According to this design, the electrical power connector comprises an electrically insulative housing A, which comprises a mating portion A1, a mating chamber A10 defined in the mating portion A1 and a plurality of vent holes A11 cut through the top wall of the mating portion A1, and conducting terminals B mounted in the mating chamber A10 inside the mating portion A1. When the mating portion A1 of the electrical power connector is fastened to a connection portion of a circuit board, the connection portion of the circuit board occupies much the inside space of the mating portion A1. Thus, during transfer of a high current through the conducting terminals B, the generated heat cannot be quickly dissipated through the vent holes A11 into the atmosphere. Accumulation of waste heat in the mating portion A1 will affect the power transfer performance of the electrical power connector.

Therefore, it is desirable to provide an electrical power connector having a wide heat dissipation surface area for quick dissipation of heat.

### SUMMARY OF THE INVENTION

The present invention has been accomplished under the circumstances in view. It is therefore the main object of the present invention to provide an electrical power connector, which effectively reduces the operating conducting terminal impedance and temperature.

To achieve this and other objects of the present invention, an electrical power connector comprises an electrically insulative housing, pairs of conducting terminals, and a heat dissipation mechanism. The electrically insulative housing comprises a plurality of mating portions arranged in parallel at the front side thereof, a plurality of partition plates disposed at the rear side thereof, an accommodation chamber defined between each two adjacent partition plates corresponding to one respective mating portion, a mating chamber defined in each mating portion, and a plurality of mounting holes located on opposing top and bottom sides of the mating portions. The pairs of conducting terminals are respectively mounted in the accommodation chambers of the electrically insulative housing. The heat dissipation mechanism comprises a plurality of thermal conductive metal plates covered on the mating portions of the electrically insulative housing for quick dissipation of heat. Each thermal conductive metal plate comprises at least one mounting lug respectively fastened to one respective mounting hole of the electrically insulative housing.

Subject to the thermal conductivity characteristics of the metal plates, the arrangement of the heat dissipation mechanism facilitates heat dissipation to effectively lower the temperature of the conducting terminals, thereby minimizing variation of the electrical characteristics of the electrical power connector.

Further, the metal plates of high thermal conductivity of the heat dissipation mechanism can be U-shaped meal plates respectively capped on the top and bottom sides of the mating portions of the electrically insulative housing. Alternatively, the metal plates of high thermal conductivity of the heat dissipation mechanism can be angle plates respectively capped on the four corner areas of the mating portions of the electrically insulative housing. Further, the heat dissipation mechanism can also be covered on the mating portions as well as other part of the electrically insulative housing to enhance heat dissipation, increasing the current carrying capacity of the electrical power connector.

### BRIEF DESCRIPTION OF THE DRAWINGS

FIG. 1 is an elevational view of an electrical power connector in accordance with the present invention.

FIG. 2 is an exploded view of the electrical power connector in accordance with the present invention.

FIG. 3 corresponds to FIG. 2 when viewed from another angle.

FIG. 4 is a schematic front sectional view of the electrical power connector before positioning of the heat dissipation mechanism.

FIG. 5 is a schematic front sectional view of the present invention, illustrating the heat dissipation mechanism attached to the electrically insulative housing of the electrical power connector.

FIG. 6 is a schematic sectional elevation illustrating the relationship between the mating portions of the electrically insulative housing of the electrical power connector and the connection portions of a circuit board in accordance with the present invention.

FIG. 7 is a sectional side view of the present invention, illustrating the respective connection portions of the circuit board inserted into the mating portions of the electrically insulative housing and kept in contact with the respective conducting terminals and signal terminals.

FIG. 8 is an elevational view of an electrical power connector according to the prior art.

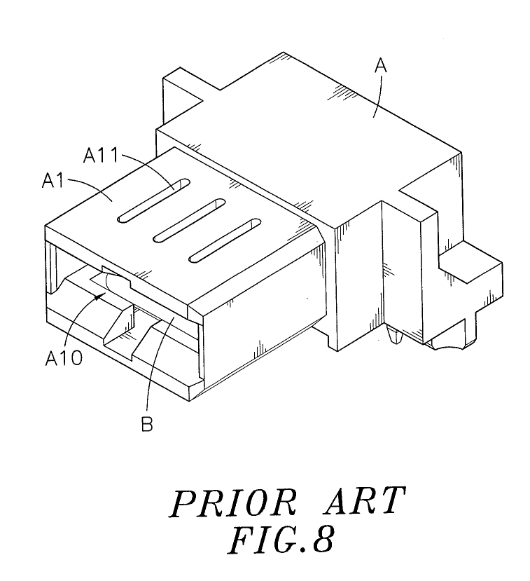

### DETAILED DESCRIPTION OF THE PREFERRED EMBODIMENT

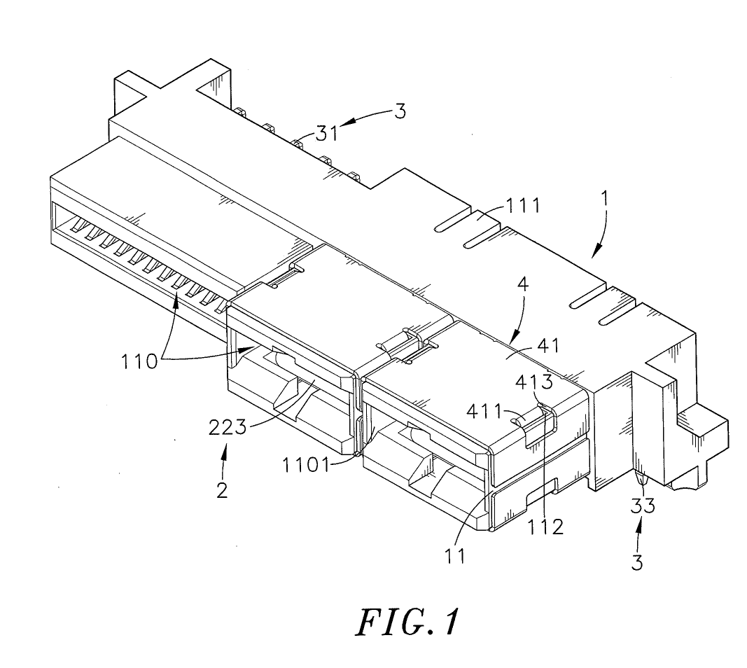

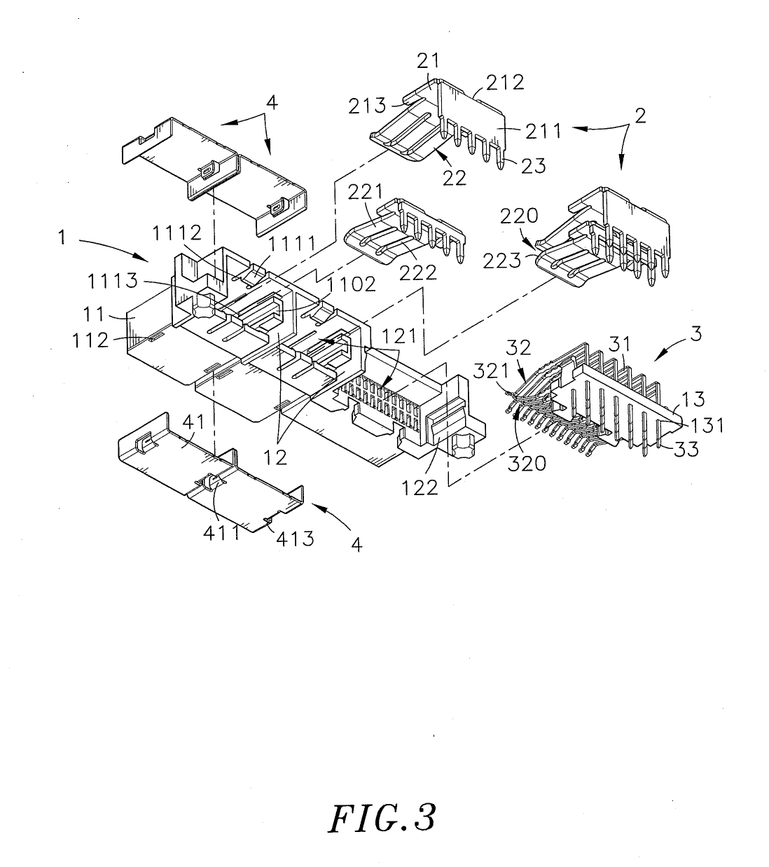

Referring to FIGS. 1, 2 and 3, an electrical power connector in accordance with the present invention is shown. The electrical power connector comprises an electrically insulative housing 1, and a plurality of conducting terminals 2.

The electrically insulative housing 1 comprises a plurality of mating portions 11 arranged in parallel at a front side thereof, a plurality of partition plates 12 disposed at a rear side thereof, an accommodation chamber 121 defined between each two adjacent partition plates 12 corresponding to one respective mating portion 11, a mating chamber 110 defined in each mating portion 11 and defining a front opening 1101 in communication with one respective accommodation chamber 121, two guide grooves 1102 bilaterally disposed in each mating chamber 110 between the associating front opening 1101 and accommodation chamber 121, and a plurality of springy hooks 111 extended from opposing top and bottom sides thereof and respectively suspending in top and bottom sides in each accommodation chamber 121. Further, each springy hook 111 defines a bevel face 1111 located on a distal end thereof, a vertical stop edge 1112 disposed at a back side of the bevel face 1111, and a stepped rear stop portion 1113 disposed adjacent to the associating mating chamber 110.

The conducting terminals 2 are arranged in pairs and respectively mounted in the accommodation chambers 121 of the electrically insulative housing 1. Each of the two vertically arranged conducting terminals 2 in each accommodation chamber 121 comprises a panel base 21 having a vertically downwardly extending rear connection portion 211, an opening 212 cut through opposing top and bottom sides of the rear connection portion 211 of the panel base 21, a front mating end portion 22 forwardly extended from the panel base 21 and suspending in the front opening 1101 of the corresponding accommodation chamber 121, two stop rods 213 forwardly extended from the panel base 21 and suspending at two opposite lateral sides relative to the front mating end portion 22, and a rear bonding end portion 23 downwardly extended from the rear connection portion 211 of the panel base 21. Further, a retaining gap 220 is defined between the two vertically arranged conducting terminals 2 in each accommodation chamber 121 of the electrically insulative housing 1. Further, the front mating end portion 22 of each conducting terminal 2 defines a turning face 221, at least one, for example, two longitudinal slots 222 cut through opposing top and bottom sides of the turning face 221, and a front guide slope 223 obliquely downwardly (or obliquely upwardly) extended from the turning face 221.

When assembling the electrical power connector, insert the front mating end portions 22 of each pair of conducting terminals 2 into each respective accommodation chamber 121 between each two respective partition plates 12 of the electrically insulative housing 1 against the bevel faces 1111 of the respective two springy hooks 111. At this time, the respective springy hooks 111 are elastically deformed for allowing the front mating end portions 22 of the respective pair of conducting terminals 2 to pass. When the front mating end portions 22 of each pair of conducting terminals 2 are set in position in the accommodation chamber 121, the respective springy hooks 111 immediately return to their former shape to engage the vertical stop edges 1112 thereof into the openings 212 of the respective conducting terminals 2 and to abut the stepped rear stop portions 1113 thereof against the stop rods 213 of the respective conducting terminals 2, and therefore the respective conducting terminals 2 are locked to the electrically insulative housing 1 by the respective springy hooks 111.

According to this embodiment, the electrically insulative housing 1 comprises three mating portions 11, one configured subject to a first configuration design, and the other two configured subject to a second configuration design. The mating portion 11 configured subject to the first configuration design comprises a bottom opening 122 at the bottom side of the accommodation chamber 121, and a terminal block 13 mounted in the bottom opening 122. The terminal block 13 holds two vertically spaced sets of signal terminals 3. Each signal terminal 3 comprises a base portion 31, a front contact portion 32 forwardly extended from the base portion 31 and terminating in a spring arm 321 in the front opening 1101 of the respective accommodation chamber 121, and a rear bonding portion 33 backwardly extended from the base portion 31 and downwardly inserted through one respective terminal hole 131 of the terminal block 13. Further, a retaining gap 320 is defined between the front contact portions 32 of the two vertically spaced sets of signal terminals 3.

As stated above, the electrically insulative housing 1 comprises three mating portions 11, one configured subject to the first configuration design, and the other two configured subject to the second configuration design, wherein the mating portion 11 configured subject to the first configuration design is adapted for accommodating signal terminals 3, and the other two mating portions 11 configured subject to the second configuration design are adapted for accommodating the conducting terminals 2. Although the number and shape between the signal terminals 3 and the conducting terminals 2 are different, the mounting arrangement of the signal terminals 3 is substantially similar to that of the conducting terminals 2.

Further, snap-fit, interference fit, friction fit, or any other fastening techniques may be employed to facilitate installation of the conducting terminals 2 and the signal terminals 3 in the mating chambers 110 inside the mating portions 11 of the electrically insulative housing 1.

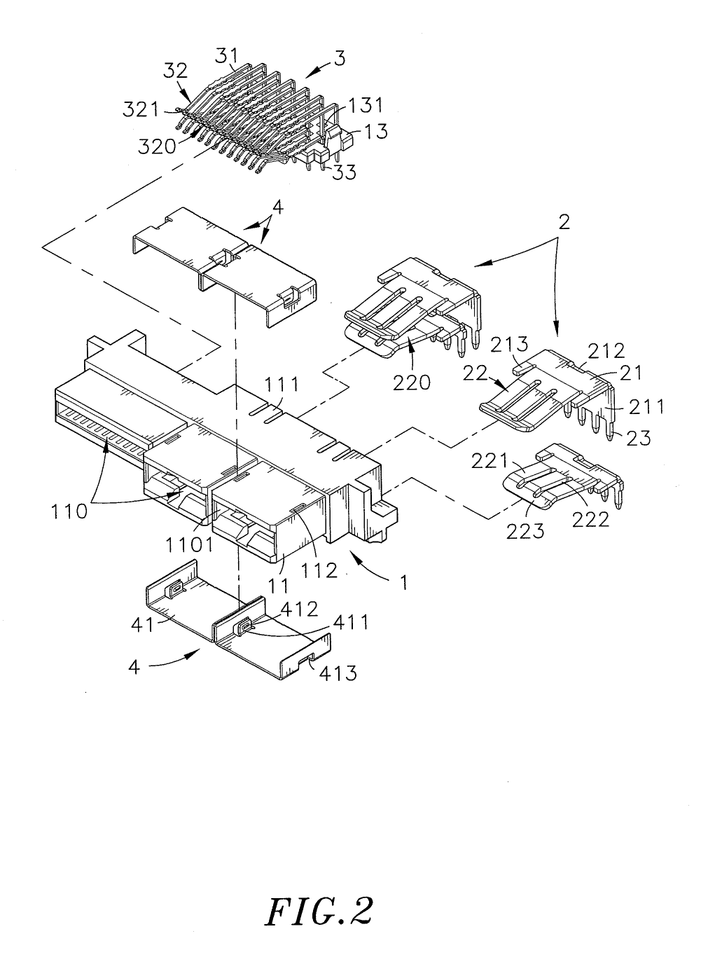

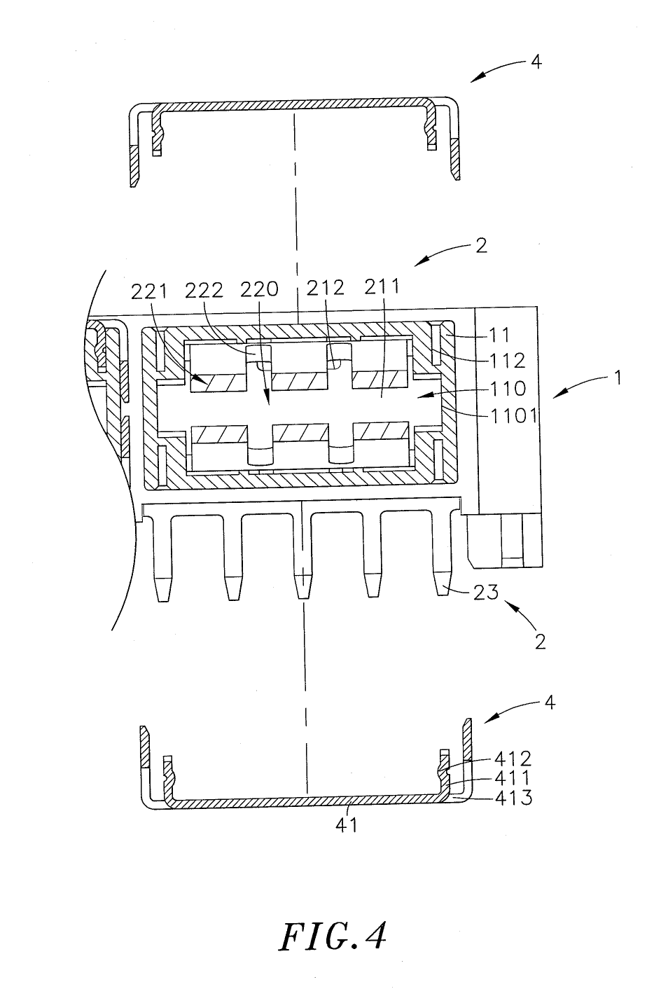

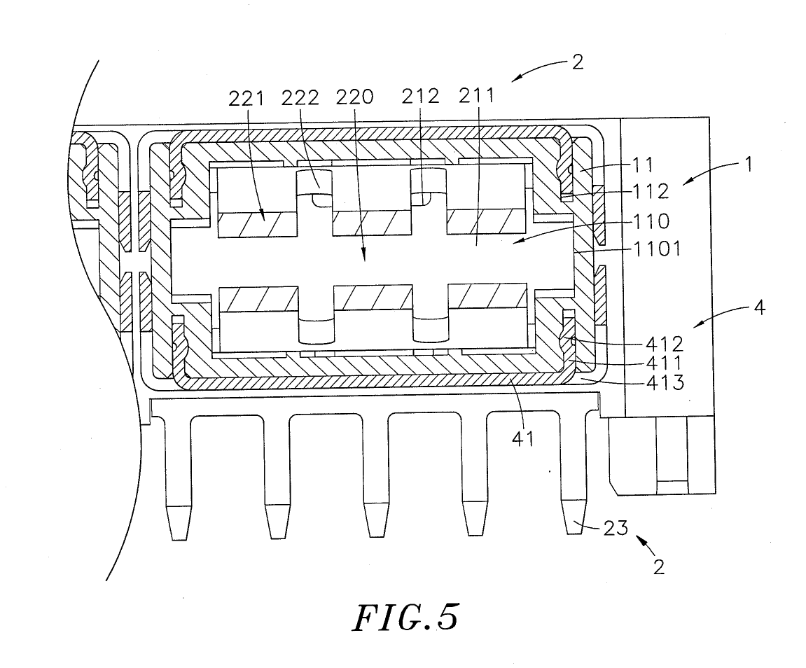

Referring to FIGS. 4 and 5 and FIGS. 2 and 3 again, electrical power connector further comprises a heat dissipation mechanism 4. Further, the electrically insulative housing 1 further comprises a plurality of mounting holes 112 located on opposing top and bottom sides of each of the two mating portions 11 configured subject to the second configuration design. The heat dissipation mechanism 4 comprises a plurality of metal plates 41 of high thermal conductivity respectively attached to the opposing top and bottom sides of each of the two mating portions 11 configured subject to the second configuration design. Each metal plate 41 comprises two opposing side openings 413, two mounting lugs 411 respectively disposed adjacent to the side openings 413 and respectively inserted into the two mounting holes 112 at the top side of the respective mating portion 11, and a raised portion 412 protruded from each of the mounting lugs 411 and forced into friction engagement with the inside wall of the respective mounting hole 112 of the respective mating portion 11.

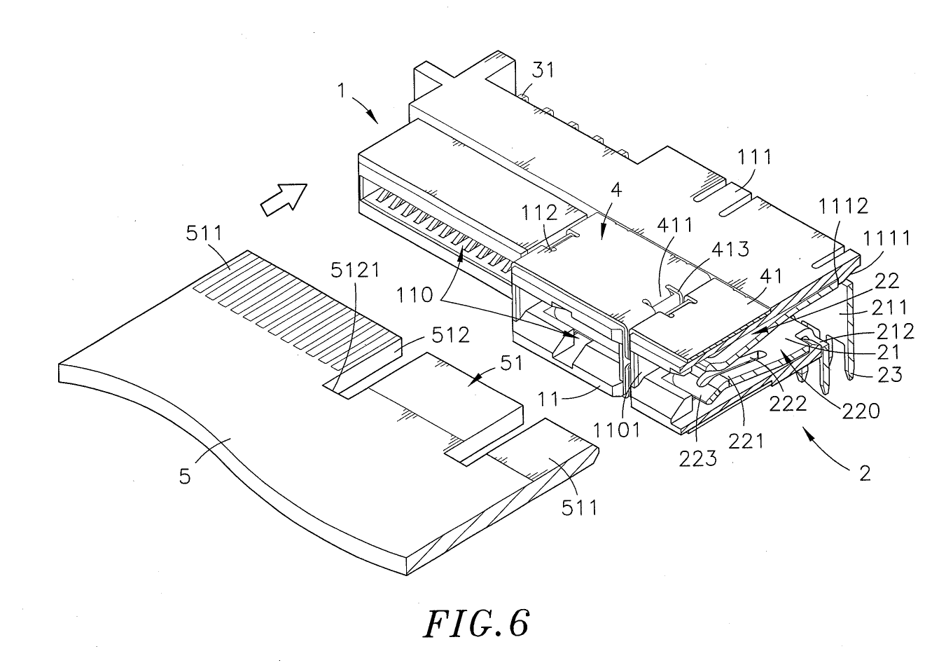

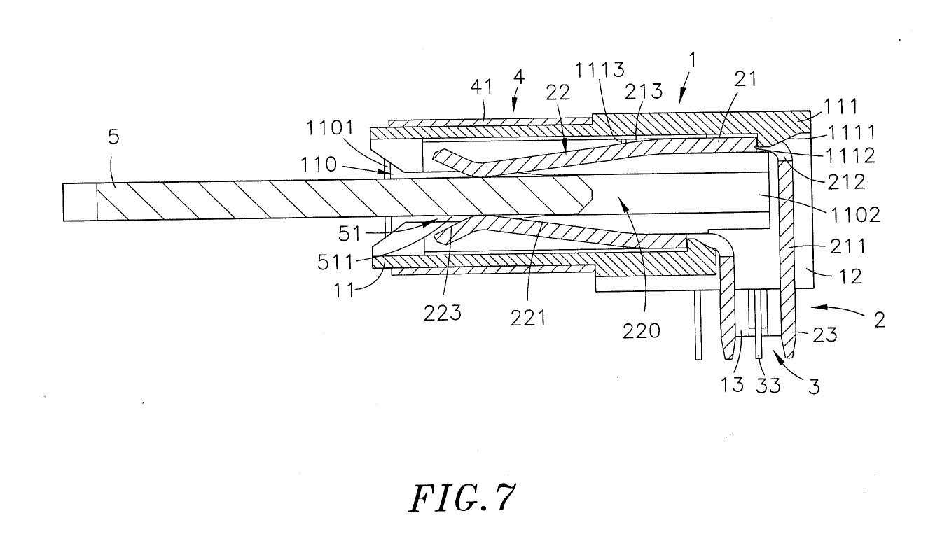

During transmission of a high current after installation of the electrical power connector in a circuit board 5 (see also FIGS. 6 and 7), heat generated by the conducting terminals 2 can be dissipated into the atmosphere through the gaps between the vertically arranged conducting terminals 2 in the accommodation chambers 121. Further, the thickness of the circuit board 5 is much smaller than the height of the mating chambers 110 of the mating portions 11 of the electrically insulative housing 1. After insertion of respective connection portions 51 of the circuit board 5 into the mating chambers 110 of the mating portions 11 of the electrically insulative housing 1, currents of air caused by an electric fan can be guided through the mating chambers 110 of the mating portions 11 of the electrically insulative housing 1 to lower the temperature of the conducting terminals 2.

Further, the metal plates 41 of high thermal conductivity of the heat dissipation mechanism 4 can be U-shaped meal plates respectively capped on the top and bottom sides of the mating portions 11 of the electrically insulative housing 1. Alternatively, the metal plates 41 of high thermal conductivity of the heat dissipation mechanism 4 can be angle plates respectively capped on the four corner areas of the mating portions 11 of the electrically insulative housing 1. Subject to the thermal conductivity characteristics of the metal plates 41, the arrangement of the heat dissipation mechanism 4 facilitates heat dissipation to effectively lower the temperature of the conducting terminals 2, thereby minimizing variation of the electrical characteristics of the electrical power connector. Further, the heat dissipation mechanism 4 can also be covered on the mating portions 11 as well as other part of the electrically insulative housing 1 to enhance heat dissipation, increasing the current carrying capacity of the electrical power connector under a same temperature rise (for example, 30° C.) and improving power transfer efficiency and safety.

Referring to FIGS. 6 and 7, the aforesaid circuit board 5 comprises two front notches 512 respectively defined between each two adjacent connection portions 51, and a stop edge 5121 in each front notch 512, and a plurality of electric contacts 511 located on the opposing top and bottom sides of the connection portions 51.

During installation, the connection portions 51 of the circuit board 5 are respectively inserted through the front openings 1101 of the mating chambers 110 of the mating portions 11 of the electrically insulative housing 1 into the respective guide grooves 1102 in the respective mating chambers 110 and the retaining gaps 220 between the front mating end portions 22 of the respective vertically arranged conducting terminals 2 or the retaining gap 320 between the front contact portions 32 of the two vertically spaced sets of signal terminals 3. When set in position, the stop edges 5121 in the front notches 512 of the connection portions 51 of the circuit board 5 are respectively stopped against the front side of the mating portions 11 of the electrically insulative housing 1, and the turning faces 221 of the front mating end portions 22 of the conducting terminals 2 and the spring arm 321 of the front contact portions 32 of the signal terminals 3 of the terminal block 13 are respectively kept in contact with the respective electric contacts 511 at the connection portions 51 of the circuit board 5 positively. At this time, the front mating end portions 22 of the conducting terminals 2 and the spring arm 321 of the front contact portions 32 of the signal terminals 3 of the terminal block 13 are respectively stopped at the opposing top and bottom sides of the respective electric contacts 511 at the connection portions 51 of the circuit board 5 in a balanced manner to evenly distribute the bearing pressure, less impedance and temperature will be produced during transmission of electric current or signal, assuring a high level of power or signal transmission reliability and safety.

As stated above, the electrically insulative housing 1 comprises a plurality of mounting holes 112 located on opposing top and bottom sides of the two mating portions 11 thereof for securing metal plates 41 of a heat dissipation mechanism 4 that facilitates heat dissipation to effectively lower the temperature of the conducting terminals 2. Subject to the use of the heat dissipation mechanism 4, the invention enhances heat dissipation, increasing the current carrying capacity of the electrical power connector under a same temperature rise (for example, 30° C.).

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. An electrical power connector, comprising:
an electrically insulative housing comprising a plurality of mating portions arranged in parallel at a front side thereof, a plurality of partition plates disposed at a rear side thereof, an accommodation chamber defined between each two adjacent said partition plates corresponding to one respective said mating portion, a mating chamber defined in each said mating portion, said mating chamber defining a front opening, and a plurality of mounting holes located on opposing top and bottom sides of said mating portions
a plurality of conducting terminals arranged in pairs and respectively mounted in said accommodation chambers of said electrically insulative housing, each said conducting terminal comprising a panel base, a front mating end portion forwardly extended from said panel base and suspending in the front opening of one said mating chamber, and a rear bonding end portion backwardly downwardly extended from said panel base; and
a heat dissipation mechanism comprising a plurality of thermal conductive metal plates covered on said mating portions of said electrically insulative housing, each said thermal conductive metal plate comprising at least one mounting lug fastened to one said mounting hole of said electrically insulative housing.

2. The electrical power connector as claimed in claim 1, wherein each said thermal conductive metal plate comprises an opening disposed around each said mounting lug.

3. The electrical power connector as claimed in claim 2, wherein each said thermal conductive metal plate further comprises a raised portion protruded from each said mounting lug and forced into friction engagement with an inside wall of the respective mounting hole of said electrically insulative housing.

4. The electrical power connector as claimed in claim 1, wherein the front mating end portion of each said conducting terminal defines a turning face, at least one longitudinal slot cut through opposing top and bottom sides of said turning face, and a front guide slope obliquely extended from said turning face.

5. The electrical power connector as claimed in claim 1, wherein each said thermal conductive metal plate comprises an opening disposed around each said mounting lug, and a raised portion protruded from each said mounting lug and forced into friction engagement with an inside wall of the respective mounting hole of said electrically insulative housing.
